(19) United States
(12) Patent Application Publication
(10) Pub. No.: US 2013/0331888 A1
(43) Pub. Date: Dec. 12, 2013

(54) Liquid Fillable and Liquid Communicating Pacifier

(71) Applicant: Michelle Antinnes, Tunkhannock, PA (US)

(72) Inventor: Michelle Antinnes, Tunkhannock, PA (US)

(21) Appl. No.: 13/909,235

(22) Filed: Jun. 4, 2013

Related U.S. Application Data
(60) Provisional application No. 61/657,131, filed on Jun. 8, 2012.

(51) Int. Cl. A61J 17/00

(52) U.S. Cl. CPC A61J 17/00
USPC 606/236

(57) ABSTRACT

An infant pacifier is provided with a nipple having a fillable interior volume, whereby fluid can be communicated into the nipple interior and thereafter frozen. The nipple secures to a pacifier guard that prevents swallowing of the device, while the distal end of the nipple includes an aperture for communicating the frozen contents of the nipple interior into the infant's mouth as the fluid melts. The device soothes the infant's gums while frozen, provides a compressible pacifier structure, and further provides a means to communicate flavored water into the infant's mouth for calming and enjoyment purposes.

### CROSS REFERENCE TO RELATED APPLICATION

This application claims the benefit of U.S. Provisional Application No. 61/657,131 filed on Jun. 8, 2012, entitled “Icy Paci.” The above identified patent application is herein incorporated by reference in its entirety to provide continuity of disclosure.

### BACKGROUND OF THE INVENTION

1. Field of the Invention

The present invention relates to infant pacifiers, teething toys, and methods of treating infantile colic. More specifically, the present invention pertains to a new and novel pacifier device that includes a hollow nipple having access to fill the nipple with chilled and flavored liquid material, which slowing exits the end of the nipple and enters the infant's mouth.

Many infants experience pain and discomfort while teething, which can result in agitation and periods of crying. Still others experience colic and are prone to crying for long periods of time if not provided a means of distraction or occupation. Infant pacifiers are effective tools for calming an infant and diverting his or her attention from any immediate pain or discomfort. This is particularly true as the infant's teeth emerge, where this process tends to cause significant discomfort for the child as the teeth break through the gums.

Pacifiers are oral appliances that generally include an elastomeric nipple supported by a mouth shield or guard that prevents the child from swallowing the nipple. The nipple is formed so that the baby can chew and suck on the structure, while the shield extends outward to press against the sides of the infant's mouth to prevent the nipple from entering too far into the oral cavity. The nipple is a structure that the infant can chew upon while teeth or suck upon for comfort and for soothing. Use of a pacifier structure is well known in the art for reducing stress on an infant and to cease periods of crying. A handle is also generally provided along the outer surface of the pacifier guard for easily removing the pacifier from the infant's mouth when desired.

While pacifiers are well known structures in the art, these devices generally do not treat sore or teething gums or provide any active treatment for a child in pain. These devices are generally distractive devices that divert attention away from immediate pain and sooth a crying child. Treatments that have been shown to be effective for teething include chilled teething toys, which cool the gums and reduce inflammation and associated pain. A need exists, therefore, for a pacifier structure that combines the standard benefits of a pacifier device with a means of soothing teething infant gums.

The present invention discloses such a pacifier, wherein the device includes a nipple having an open cavity to accept a freezable liquid therein. The nipple interior is accessible for filling and for communicating the liquid therefrom after a period of use as the frozen liquid begins to melt. The device comprises a nipple having a distal end with a self-sealing slit or pin-hole therealong, which permits a melting, flavored liquid to pass therethrough and into the infant's mouth for enjoyment. At the same time, the frozen liquid soothes the infant's gums and provides a structure for the child to chew upon. The nipple is either removable from the guard and fillable thereafter, or alternatively a fill-door is provided through the guard for refilling the nipple with liquid prior to placement in a freezer for freezing the same.

2. Description of the Prior Art

Devices have been disclosed in the prior art that relate to pacifier devices and infant chew toys. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Specifically, U.S. Patent Publication No. 2003/0014078 to Robbins discloses a baby teething pacifier that includes a porous, permeable material containing a frozen liquid therein. The material creates a container for opening and receiving frozen liquid therein, which is adapted to melt into the infant's mouth. While disclosing a structure that supports a frozen liquid for soothing a teething infant, the structure of the Robbins device is not well suited for use as a communication means of fluid or as a pacifier structure. The Robbins device is further not cleanly and easily cleaned. The present invention provides a generic pacifier structure having an internal cavity to accept a liquid volume therein, where the pacifier can be enjoyed just as a normal pacifier would otherwise be utilized.

U.S. Pat. No. 5,658,314 to Scheffer discloses a teething pacifier structure that includes an interior cavity filled with a freezable liquid. The liquid is frozen within the pacifier nipple, which then melts and flows into an expansion chamber or reservoir as it transforms to liquid. The liquid can then be refrozen and reused. The present invention, while providing a pacifier with a frozen liquid interior, contemplates that the liquid, preferably flavored, be capable of escaping the distal end of the nipple as it melts. In this way, the infant can be soothed by the cooling effect of the frozen pacifier nipple, and further enjoy the taste of the liquid escaping therefrom. The liquid is adapted to be refilled after the device is cleaned for reuse.

Finally, U.S. Pat. No. 3,669,117 to Herbst discloses a combination teether and pacifier device that comprises a thin walled, flexible body having an interior filled with a compressible gel or liquid fill. The fill can communicate between the teether and pacifier end of the device, however the device fails to contemplate a freezable material that can communicate out of the device and into the infant's mouth for ingestion.

The present invention discloses an infant pacifier device that includes an open nipple interior for accepting liquid thereinto, whereafter the device can be placed into a freezer for freezing the liquid therein. As the liquid melts, it passes through an aperture in the nipple distal end and into the infant's mouth, thereby providing a flavor for the infant to enjoy while his or her gums are soothed by the frozen liquid. The infant can further chew on the device as would a generic pacifier device.

Overall, it is submitted that the present invention is substantially divergent in design elements from the prior art, and consequently it is clear that there is a need in the art for an improvement to existing infant pacifier devices. In this regard the instant invention substantially fulfills these needs.

### SUMMARY OF THE INVENTION

In view of the foregoing disadvantages inherent in the known types of infant pacifiers now present in the prior art, the present invention provides a new pacifier structure that can be utilized for providing convenience for the user when comforting a teething, colic, or fussy infant.

It is therefore an object of the present invention to provide a new and improved infant pacifier device that has all of the advantages of the prior art and none of the disadvantages.

It is another object of the present invention to provide an infant pacifier device that includes nipple having a fillable interior volume that is adapted to accept a freezable liquid therein.

Another object of the present invention is to provide an infant pacifier device that communicates melting fluid from within its nipple interior into the infant's mouth for soothing the infant and for his or her taste enjoyment.

Yet another object of the present invention is to provide an infant pacifier device that includes a simple pacifier structure comprising a nipple, guard, and means of filling and re-filling the nipple interior with liquid for subsequent freezing and consumption.

Another object of the present invention is to provide an infant pacifier device that includes a fluid delivery aperture along the distal end of the nipple that the infant can suck fluid through, but for which the aperture does not permit ready fluid communication under a static state such that filling the nipple interior does not cause the fluid to exit the nipple distal end and cause spillage.

Another object of the present invention is to provide an infant pacifier device that includes a structure that promotes economy and ease of manufacture for producibility and for ready purchase by parents and caretakers of infants.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an exemplary embodiment of the present invention.

FIG. 2 shows an overhead view of the exemplary embodiment of the present invention.

FIG. 3 shows a view of the nipple being removed from the pacifier guard for liquid filling.

FIG. 4 shows an alternate embodiment of the pacifier which contemplates a fixed connection between the nipple and guard, wherein the guard includes a fill door for communicating fluid therethrough and into the nipple interior.

### DETAILED DESCRIPTION OF THE INVENTION

Reference is made herein to the attached drawings. Like reference numerals are used throughout the drawings to depict like or similar elements of the infant pacifier. For the purposes of presenting a brief and clear description of the present invention, the preferred embodiment will be discussed as used for soothing teething gums, for pacifying a colic infant, and for providing a means of communicating flavored fluid to the infant. The figures are intended for representative purposes only and should not be considered to be limiting in any respect.

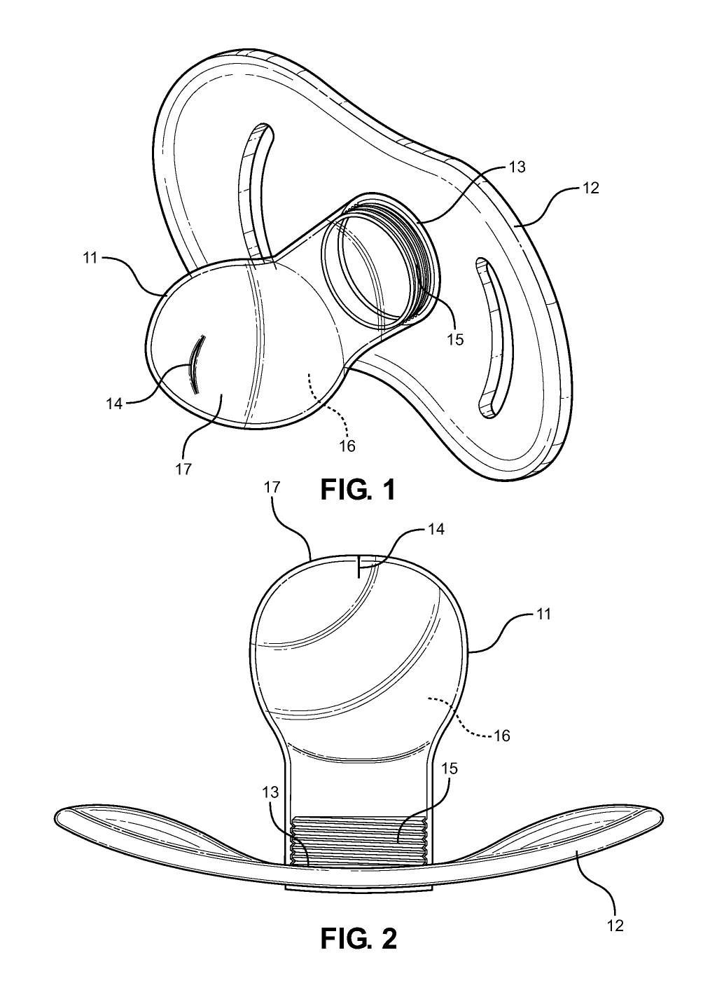

Referring now to FIG. 1, there is shown a perspective view of the pacifier structure of the present invention, wherein the device is shown in an exemplary embodiment. The device comprises an elastomeric nipple 11 having a distal end 17 and a proximal end 13. The nipple proximal end 13 attaches to a pacifier guard 12 that extends laterally outward from the lengthwise direction of the nipple 11 such that the nipple cannot be ingested into an infant's mouth beyond a given point. The guard 12 presses against an infant's mouth and face such that the nipple 11 does not enter the infant's throat and cause a choke hazard.

The nipple 11 itself is a fluid containment and delivery structure, whereby the nipple 11 includes an a formed surface having an open interior volume 16, a means of entering fluid into the nipple interior 16, and a liquid communication aperture or slit 14 along the nipple distal end 17. The nipple 11 is adapted to accept a fluid therein, whereafter the device is placed into a freezer for freezing the liquid within the nipple 11. The device is then removed from the freezer and given to an infant. Heat from the infant's mouth causes the frozen liquid within the nipple interior 16 to melt over a period of time. As the child sucks on the nipple 11, the melting liquid communicates through the distal end slit 14 and into the infant's mouth.

The aperture or slit 14 along the nipple distal end 17 is a port that allows liquid communication out of the nipple interior when the child is sucking on the nipple or compressing the nipple by chewing on the same when frozen or melted contents are therein. The slit 14 contains any liquid placed into the nipple interior 16 until the infant desires the liquid to be withdrawn therefrom, or at a minimum prevents free flowing liquid therethrough that would create a spillage concern while filling the nipple interior 16. In its static state, the slit 14 is largely self-sealing and does not allow liquid to readily pass through, however as soon as the nipple 11 is compressed or sucked upon, the slit 14 opens to allow melted fluid to evacuate the nipple interior 16. In this way, the infant can suck on the nipple as the fluid melts to draw the fluid into his or her mouth for ingesting the fluid.

Referring now to FIGS. 1 and 2, the proximal end of the nipple 13 is shown having a threaded connection 15 with the pacifier guard. In this embodiment, the nipple 11 is removable from the guard 12 to provide access to the open proximal end of the nipple 11 for filling the nipple interior 16 with fluid prior to freezing. The parent can therefore separate the nipple 11 from the guard 12, fill the nipple interior 16 with fluid, reconnect the nipple 11 and guard 12 and place the assembly into a freezer to freeze the liquid contents. Once frozen, the device is deployed and the infant can suck on the chilled device and melt the liquid contents for ingestion.

The embodiment shown in FIGS. 1 and 2 is a threaded connection 15. This is one removable connection between the nipple 11 and the guard 12, where several are contemplated. Along with a threaded connection 15, alternate removable connection means between the nipple 11 and guard 12 include snap connections, latch connections, and any other operably removable connection therebetween that affects a sufficient connection so as not to pose a separation risk and choking hazard to the child while in use, while providing the parent with an easy method of separating the two structures to fill the nipple prior to use.

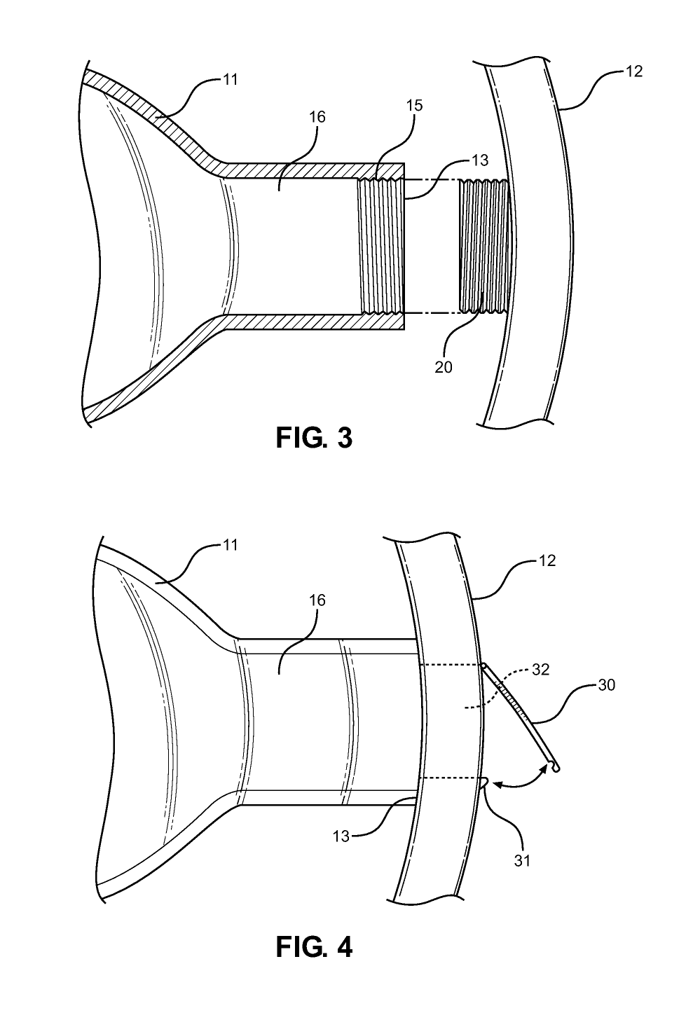

Referring now to FIG. 3, there is shown an exploded view of the threaded connection means between the nipple 11 and pacifier guard 12 of the present invention. In this embodiment, the guard includes a threaded body 20, which couples with corresponding threads 15 along the pacifier open proximal end 13. Separation of the nipple 11 from the guard 12 allows fluid to be easily communicated into the nipple interior 16 through the open proximal end 13 prior to freezing the liquid. As liquid is entered into the interior 16, the slit prevents the liquid from escaping prior to use and prior to being frozen.

The nipple structure is preferably an elastomeric structure that is readily compressible and comforting to a chew upon for a child having no teeth. As with traditional pacifier and bottle nipples, the present invention utilizes the same style structure, however provides an open nipple proximal end and means of filling the nipple interior with fluid. When filling the interior with fluid and freezing the fluid, the elastomeric structure can expand to accommodate the freezing expansion of water, if no room is provided therein for expansion. The type of liquid may be chosen by the user, including flavored water or any other ingestible and healthy fluid for an infant to consume.

Referring now to FIG. 4, there is shown a view of an alternative embodiment of the present invention, wherein the nipple 11 and pacifier guard 12 are not separable from one another and an access channel 32 is provided through the guard for filling the nipple interior 16 with fluid prior to freezing. An access door 30 is provided on the guard outer surface to secure the channel 32 closed after fluid has been communicated therethrough, where the door 30 is secured using a latch 31 or snap connection to prevent the door 30 from readily opening when not desired. This structural arrangement allows one to fill the nipple interior 16 with fluid, while also ensuring the nipple 11 will not come free from the guard 12 during use in a child's mouth, which is a safety concern otherwise.

In yet another embodiment of the present invention, liquid is adapted to be entered into the nipple distal end slit and the nipple is neither separable from the guard or accessible for liquid entry therethrough. This embodiment contemplates a largely generic pacifier structure having a distal end slit that a parent can adapt to enlarge its opening for funneling in or otherwise pouring liquid therethrough. The nipple itself is malleable, where the slit is preferably self-sealing when in a static condition. The parent can squeeze the nipple to open the slit such that liquid can be entered therethrough and into the nipple interior. After the parent releases the nipple, it reforms its shape and the slit closes onto itself for freezing the assembly in a freezer.

When infants and toddlers are teething, they can feel constant pain and soreness, which can result in crying and fussing. In turn, parents can become very frustrated, not only that the infant or toddler will not stop crying but also because the parent cannot do anything to readily solve the problem. There are various teething devices on the market to help toddlers and infants massage and cut their sore gums; however, toddlers and infants can easily lose interest in keeping these devices in their mouths.

The present invention provides parents and caregivers with a way to relieve their infant's or toddler's sore gums, as well as ensure the infant or toddler keeps the pacifier in his or her mouth. The device is a pacifier structure having a fluid containment and delivery means, whereby fluid can be accepted into the nipple interior, frozen, and then provided to the child for the child to melt and ingest the fluid for enjoyment purposes. The nipple can be filled with water, juice, or any other flavored liquid, placed into the freezer, and then used as a teether. As the liquid melts, the infant or toddler can suck on the nipple and the liquid can soothe his or her sore gums. This device is particularly useful for fussy infants, teething infants, and those infants experiencing colic.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pacifier device, comprising:
a pacifier nipple having a distal end, a proximal end, and an open interior volume;
a pacifier guard affixed to said pacifier nipple proximal end;
said nipple distal end further comprising an aperture that is adapted to allow liquid to pass therethrough when said nipple is compressed or sucked upon;
said nipple and pacifier guard having a liquid communication means wherein said nipple proximal end adapted to accept liquid therethrough and into said nipple interior volume.

2) The device of claim 1, wherein said liquid communication means further comprises a removable connection between said nipple proximal end and said pacifier guard that is adapted to expose said pacifier open proximal end.

3) The device of claim 2, wherein said removable connection further comprises a threaded connection.

4) The device of claim 2, wherein said removable connection further comprises a snap fitting connection.

5) The device of claim 1, wherein said liquid communication means further comprises a channel through said pacifier guard and an access door on said pacifier guard outer surface, said channel adapted to provide access for liquid communication through said guard and into said nipple interior volume.

6) The device of claim 1, wherein said nipple comprises an elastomeric material.

7) The device of claim 1, wherein said nipple distal end aperture is self-sealing when in a static configuration.

8) A pacifier device, comprising:
a pacifier nipple having a distal end, a proximal end, and an open interior volume;
a pacifier guard affixed to said pacifier nipple proximal end;
said nipple distal end further comprising an aperture that is adapted to allow liquid to pass therethrough when said nipple is compressed or sucked upon;
said nipple comprising an elastomeric material;
said nipple distal end aperture being self-sealing when in a static configuration;
said nipple distal end aperture being spreadable when said nipple is compressed sucked upon.
